(19) United States
(12) Patent Application Publication
(10) Pub. No.: US 2015/0113792 A1
(43) Pub. Date: Apr. 30, 2015

(54) Torque Unit, Vise Unit and Torque and Vise Apparatus and Method of Using Same

(71) Applicant: Lokrite Safety Backup LLC, Breaux Bridge, LA (US)

(72) Inventors: James L. Jacobs, Duson, LA (US); J. Brent Jacobs, Breaux Bridge, LA (US)

(73) Assignee: LOKRITE SAFETY BACKUP LLC, Breaux Bridge, LA (US)

(21) Appl. No.: 14/527,448

(22) Filed: Oct. 29, 2014

Related U.S. Application Data
(60) Provisional application No. 61/897,012, filed on Oct. 29, 2013.

(51) Int. Cl. B25B 13/50; B25B 1/20; B25B 23/00

(52) U.S. Cl. CPC B25B 13/5075; B25B 23/0085; B25B 1/20
USPC 29/559; 269/164; 269/25; 81/57.33

(57) ABSTRACT

An embodiment of the present invention is a gripping unit for engaging a workpiece with the unit including a first assembly, a second assembly pivotally connected to the first assembly and having a limited range of pivotal movement relative to the first assembly. The first and second assemblies define a central opening of the gripping unit. Each of the first and second assemblies includes a V-block oppositely disposed from one another and capable of axial translation within the central opening to engage the workpiece. An actuator is arranged and designed to pivot the second assembly relative to the first assembly in the direction of the central opening.

### CROSS-REFERENCE TO RELATED APPLICATIONS

This application claims the benefit of U.S. Provisional Application Ser. No. 61/897,012, filed Oct. 29, 2013. Applicant incorporates by reference herein Application Ser. No. 61/897,012 in its entirety.

### BACKGROUND

1. Field of the Invention

The present invention relates generally to torque units, vise units, and torque and vise apparatus, and more particularly to such units and apparatus adapted for making and breaking a threaded connection between first and second tubular members.

2. Description of Related Art

There are many situations when tubular members are joined together at their ends by threaded connections. Oftentimes, these threaded connections need to be torqued to a high torsional loading or have been subjected to high torsional loading and now requires breaking out the highly torqued threaded connection.

These types of situations exist frequently in the oilfield industry. Moreover, the torsional loads and size of equipment and tubular members present challenges in being able to efficiently and safely make or break these threaded connections.

It is desired to have an apparatus that can make and break highly torqued threaded connections between two members. Additionally, it is desired that the apparatus is safe to use and is efficient, durable, dependable and cost effective.

### BRIEF SUMMARY OF THE INVENTION

One embodiment of the present invention is a gripping unit for engaging a workpiece with the unit including a first assembly, a second assembly pivotally connected to the first assembly and having a limited range of pivotal movement relative to the first assembly. The first and second assemblies define a central opening of the gripping unit. Each of the first and second assemblies includes a V-block oppositely disposed from one another and capable of axial translation within the central opening to engage the workpiece. An actuator is arranged and designed to pivot the second assembly relative to the first assembly in the direction of the central opening.

Another embodiment is a unit including a first assembly, a second assembly pivotally connected to the first assembly and having a limited range of pivotal movement relative to the first assembly. The first and second assemblies define a central opening of the gripping unit. Each of the first and second assemblies includes a V-block oppositely disposed from one another and capable of axial translation within the central opening to engage the workpiece. An actuator is arranged and designed to pivot the second assembly relative to the first assembly in the direction of the central opening. The first assembly includes at least one track member and is movably connected to a base frame. The base frame has a plurality of guide rollers and the plurality of guide rollers and the at least one track member cooperate to allow movement of the first and second assemblies relative to the base frame.

Another embodiment is an apparatus including the above two embodiments. Still other embodiments include methods of using these units and apparatus.

### BRIEF DESCRIPTION OF THE SEVERAL VIEWS OF THE DRAWINGS

So that the manner in which the recited features, advantages and aspects of the embodiments of the present invention are attained and can be understood in detail, a more particular description of the invention, may be had by reference to the preferred embodiments thereof which are illustrated in the appended drawings, which drawings are incorporated as a part hereof.

It is to be noted however, that the appended drawings illustrate only typical embodiments of this invention and are therefore not to be considered limiting of its scope, for the invention may admit to other equally effective embodiments.

FIGS. 1 and 2 are perspective views of a torque and vise system according to a preferred embodiment of the present invention, showing a vise unit and a torque unit mounted on a system frame;

FIGS. 3 and 4 are perspective views of the front and back sides, respectively, of the vise unit shown in FIGS. 1 and 2;

FIG. 4A is an enlarged, partial elevation view of the pivot connection for the pivoting assembly of the vise unit;

FIG. 5 is a perspective view of the vise unit of FIGS. 3 and 4 with portions of the unit removed for purposes of explanation;

FIG. 5A is a front view of the vise unit of FIGS. 3 and 4 with portions of the unit removed for purposes of explanation;

FIG. 6 is a perspective view of the front side of the torque unit shown in FIGS. 1 and 2;

FIG. 7 is an elevation view of the torque unit of FIG. 6;

FIG. 7A is an enlarged elevation view of the torque unit of FIG. 7;

FIG. 7B is a view similar to FIG. 7A showing the torque unit in a pivoting and rotating position;

FIG. 8 is a front view of the torque unit of FIGS. 6 and 7 with portions of the unit removed for purposes of explanation;

FIG. 8A is an enlarged, partial elevation view of the interior member and the received V-block;

FIG. 8B is a view taken along lines 8B-8B of FIG. 8A;

FIG. 9 is a perspective, partial cutaway view showing the movable mounting of a movable, assembly to a base frame of the torque unit;

FIGS. 10 and 11 are perspective views of an alternate embodiment of the torque unit;

FIG. 12 is a front view of the torque unit of FIGS. 10 and 11 with portions of the unit removed for purposes of explanation;

FIG. 13 is a perspective view of another preferred embodiment of the torque unit; and

FIG. 14 is a front view of the torque unit of FIG. 13.

### DETAILED DESCRIPTION OF THE PREFERRED EMBODIMENTS

While this invention is susceptible of embodiments of many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

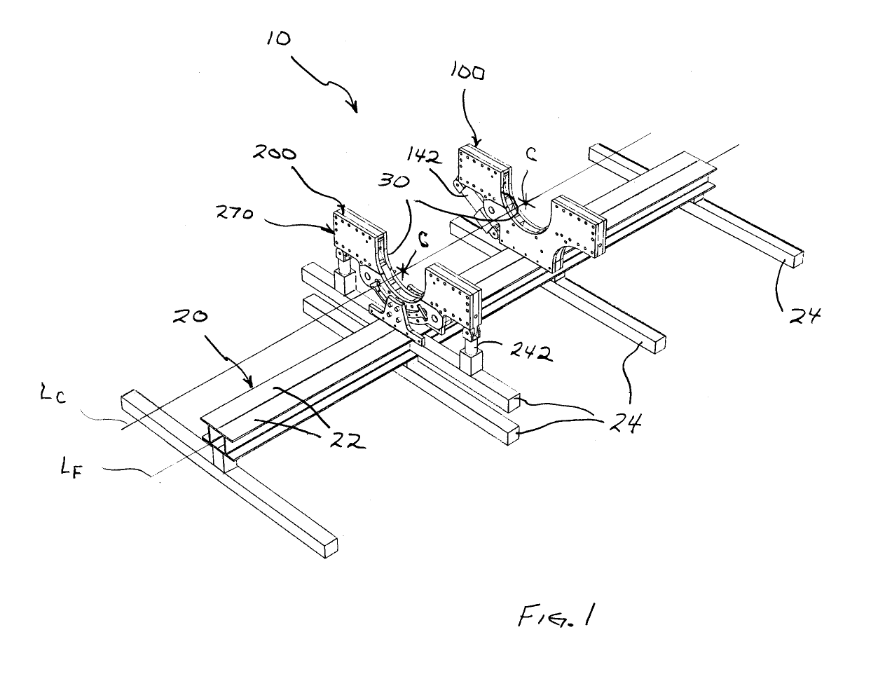

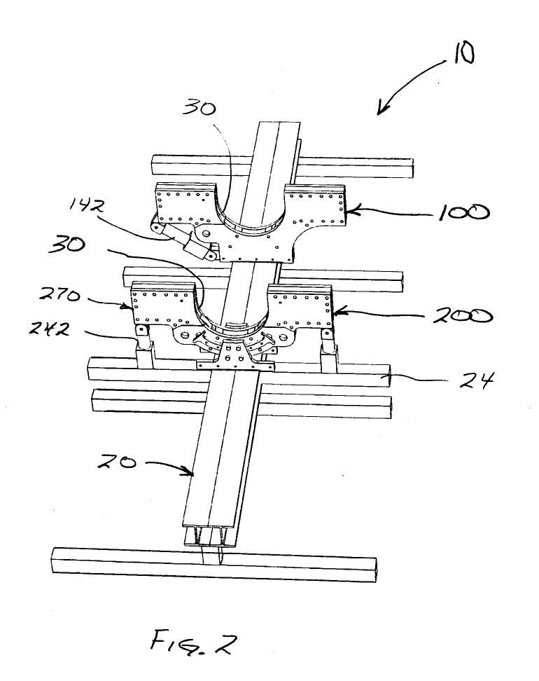

Referring to FIGS. 1 and 2, a torque and vise system according to a preferred embodiment of the present invention, generally referenced as numeral 10, is a powered system adapted for use with pipe. The torque and vise system 10 includes a vise unit 100 and a torque unit 200 mounted on a system frame 20. The system frame 20 comprises one or more beams 22 axially aligned with a central opening 30 of the vise unit 100 and the torque unit 200. Preferably, the vise and torque units are mounted to and/or supported by the support beams 22. In the embodiment illustrated in FIGS. 1 and 2, the system frame 20 also includes a plurality of cross member supports 24 spaced below the support beams 22.

Preferably, the torque unit 200 is mounted stationary on a section of a beam 22. Although not shown in the figures, it is to be understood that the vise unit 100 preferably includes means for moving the vise unit 100 axially along the beam 22 and locking it axially into place. For example, the vise unit 100 may include wheels and a lock down on the base of the vise unit 100 to allow such movement and positioning. Other examples would be known to a person of ordinary skill in the relevant art.

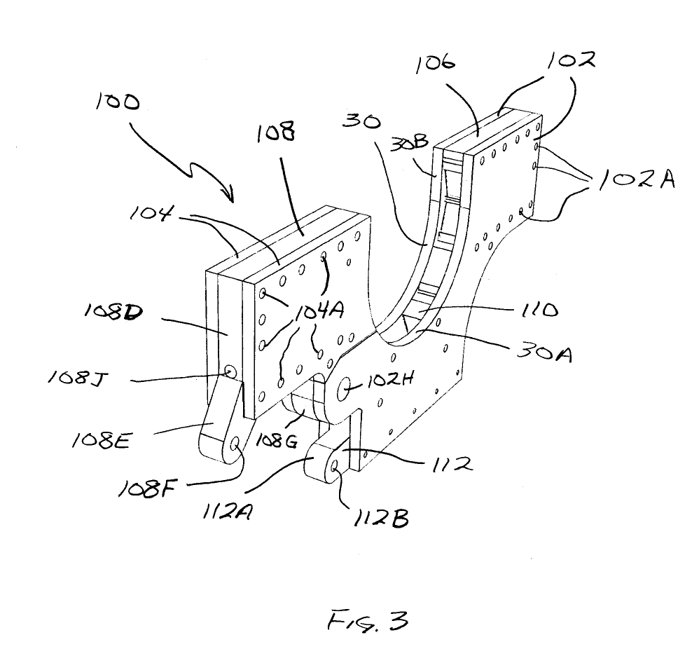

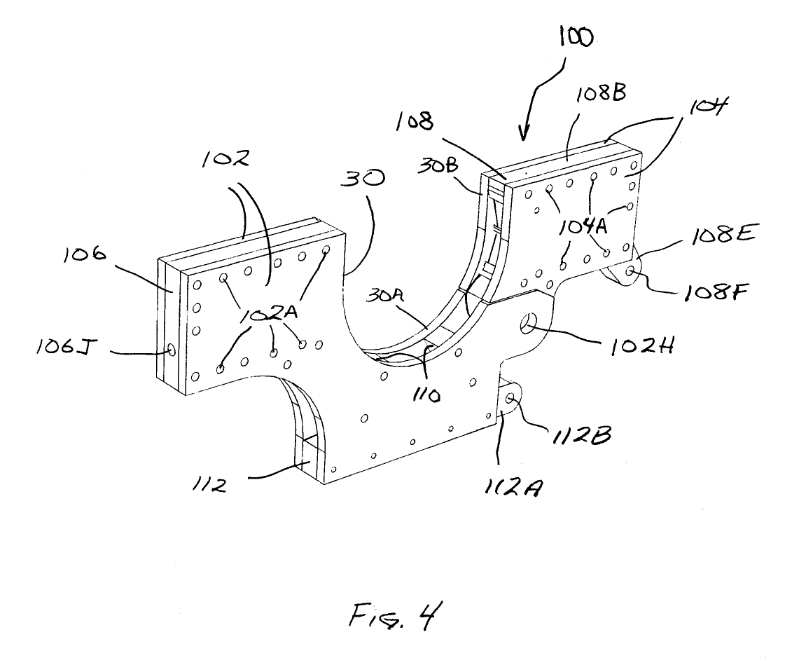

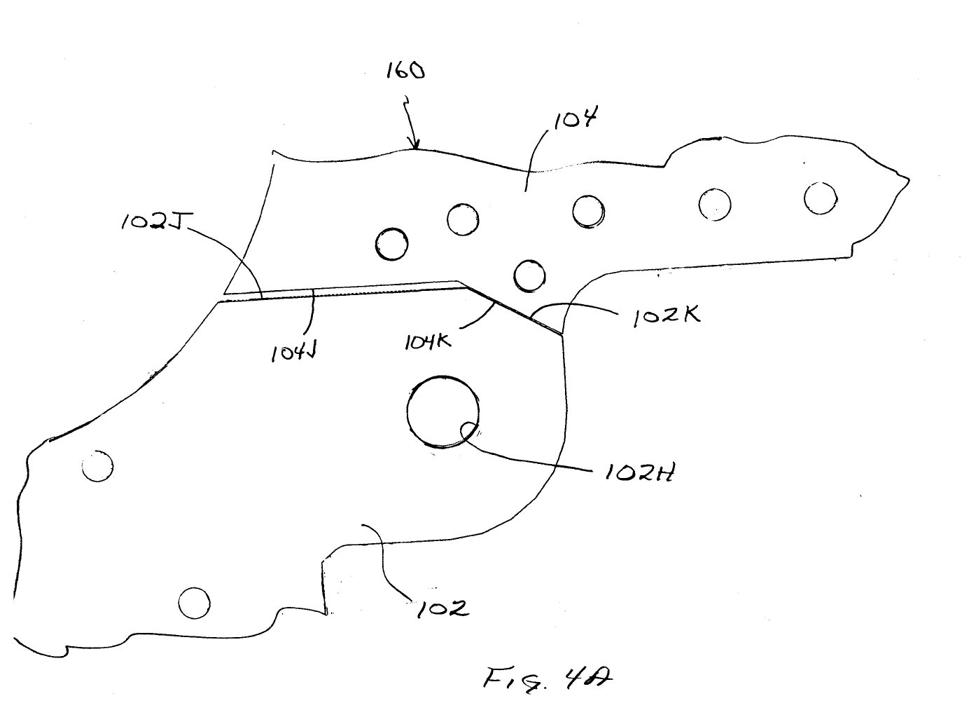

FIGS. 3 and 4 are perspective views of the front and back sides, respectively, of the vise unit 100 shown in FIGS. 1 and 2, and FIG. 5 shows the vise unit 100 with portions removed for purposes of explanation. Preferably the front and back sides of the vise unit 100 are mirror images of one another as shown in FIGS. 3 and 4. The front and back sides are each comprised of first and second members 102 and 104, respectively, preferably plate members. The first and second plate members 102 and 104 of the front side are separated from the first and second plate members 102 and 104 of the back side by first and second interior members 106 and 108, respectively.

Referring to FIGS. 3-5, an upper portion of the first plate members 102 include a plurality of holes 102A forming a fastener hole pattern and the first interior member 106 includes a corresponding plurality of holes 106A in the same fastener hole pattern. The hole patterns are shown as having fifteen (15) holes 102A or 106A extending axially through the members 102 or 106, respectively. Although not shown, it is to be understood that a plurality of fasteners, one for each hole in the pattern are inserted through the corresponding hole in the front first plate member 102, the first interior member 106 and the back first plate member 102 to secure the assembly together. Preferably, the fasteners are threaded bolts and nuts. It is to be understood that the number of holes and the hole patterns may vary depending on type and size of fasteners, load considerations and other design criteria.

Similarly, the second plate members 104 include a plurality of holes 104A forming a fastener hole pattern and the second interior member 108 includes a corresponding plurality of holes (not shown) in the same fastener hole pattern. Although not shown, it is to be understood that a plurality of fasteners, one for each hole in the pattern are inserted through the corresponding hole in the front second plate member 104, the second interior member 108 and the back second plate member 104 to secure the assembly together.

As shown in FIGS. 3-5, a pair of spacer blocks 110 are secured between the front and back first plate members 102, preferably via fasteners (not shown) extending through aligned holes in the first plate members 102 and the spacer blocks 110. The fasteners are preferably threaded bolts and nuts. A fixed strut 112 is also secured between the front and back first plate members 102 at their lower end. Preferably the fixed strut 112 and the first plate members 102 include a plurality of holes that align with one another to receive fasteners for securing the fixed strut 112 in a fixed position between the first plate members 102. The fixed strut 112 has an end 112A with a hole 112B therethrough extending beyond a lower upright edge of the first plate members 102.

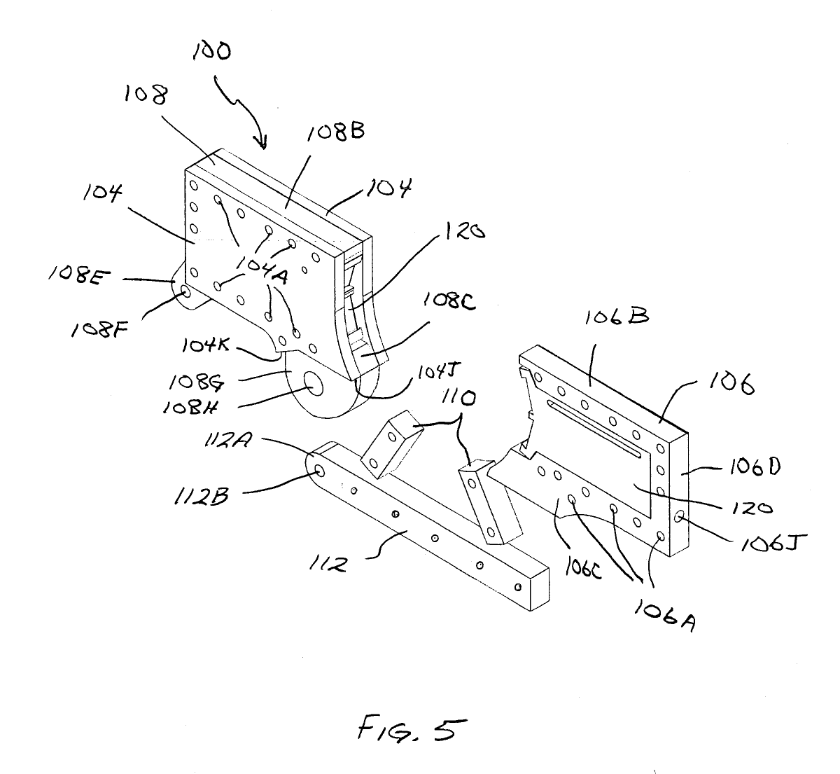

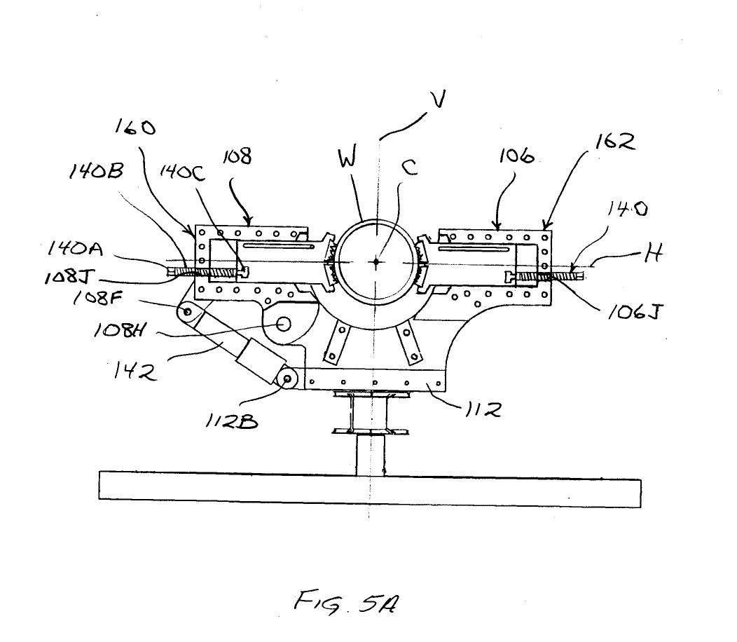

Referring to FIG. 5, the first interior member 106 includes an upper arm 106B, a lower arm 106C and a joining segment 106D. An opening is formed between the upper and lower arms 106B, 106C.

The second interior member 108 similarly includes upper and lower arms 108B and 108C respectively, and a joining segment 108D. The second interior member 108 includes a lug or push lever 108E projecting from one or both of the joining segment 108D and the lower arm 108C. The push lever 108E includes a bore 108F therethrough. At least a portion of the push lever 108E extends beyond the adjacent peripheral surface of the second plate members 104. As best shown in FIG. 5, the second interior member 108 also includes a connecting lug 108G projecting from an end of the lower arm 108C. The connecting lug 108G has an aperture 108H extending therethrough.

As shown in FIGS. 3 and 4, the first plate members 102 include an aperture 102H arranged and designed to align axially with the aperture 108H of the connecting lug 108G. Preferably, a connecting pin (not shown) is inserted into the aligned apertures 102H of the front and back first plate members 102 and aperture 108H of the second interior member 108. It is to be understood that the pin connection of the second interior member 108 to the first plate members 102 is a pivot connection.

Referring to FIGS. 3-5, a V-block 120 is received in a cavity formed by the opening between the upper and lower arms 106B and 106C respectively, of the first interior member 106 and the front and back first plate members 102. A second V-block 120 is received in the cavity formed by the opening between the upper and lower arms 108B and 108C respectively, of the second interior member 108 and the front and back second plate members 104. Preferably, the two V-blocks 120 are identical. Each V-block 120 comprises an elongate body 120A adapted to axially translate within the cavity. Various means may be used to axially translate the V-block 120. As one example, FIG. 5A shows a pair of threaded stem assemblies 140 each having an outer end 140A adapted to facilitate rotating the stem assembly 140, and a threaded portion 140B adapted to threadedly engage a threaded bore 106J, 108J of the interior member 106, 108 respectively. The stem assembly 140 includes an inner end 140C rotatably coupled to the V-block 120 in a manner such that the inner end 140C is permitted to rotate relative to the V-block 120. Preferably, the V-block 120 moves axially within the cavity as the stem assembly 140 is rotated.

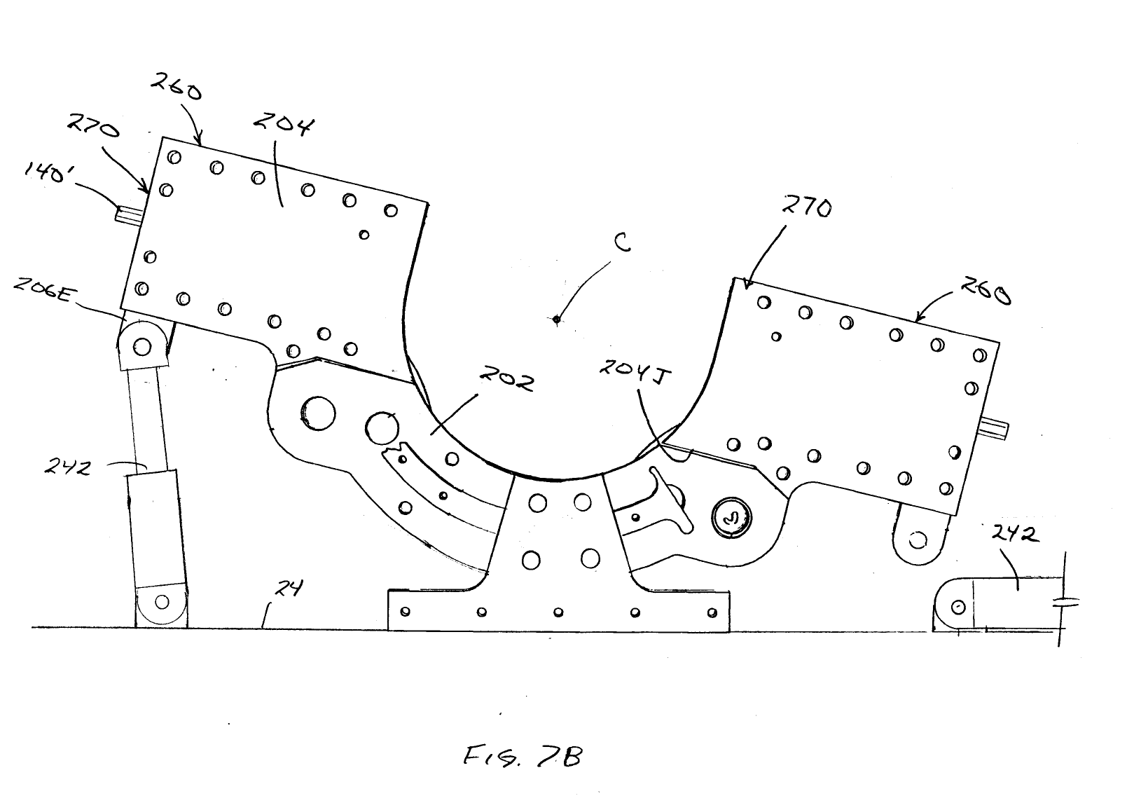

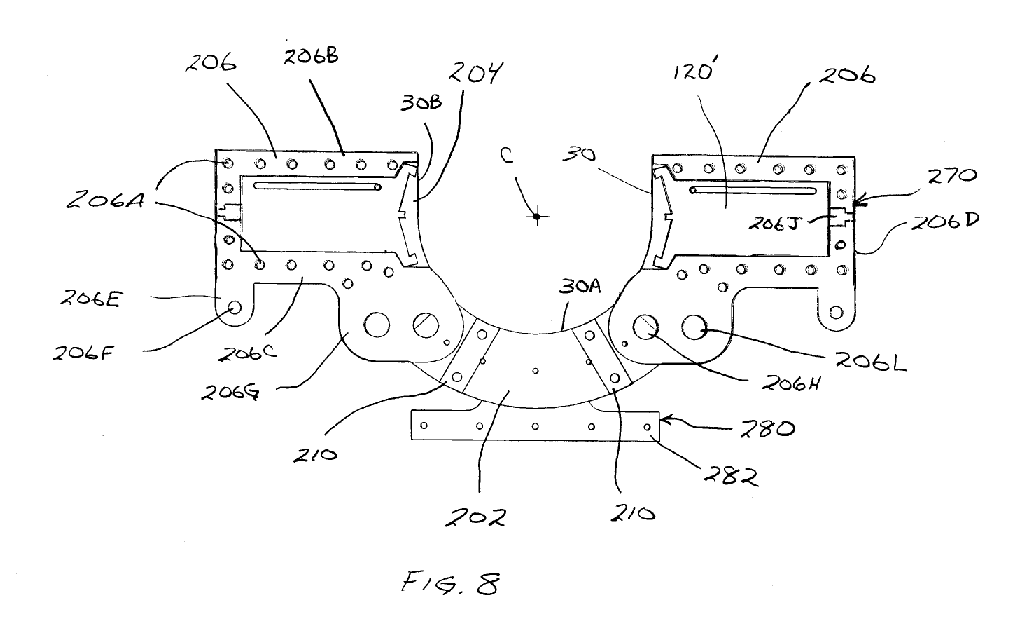

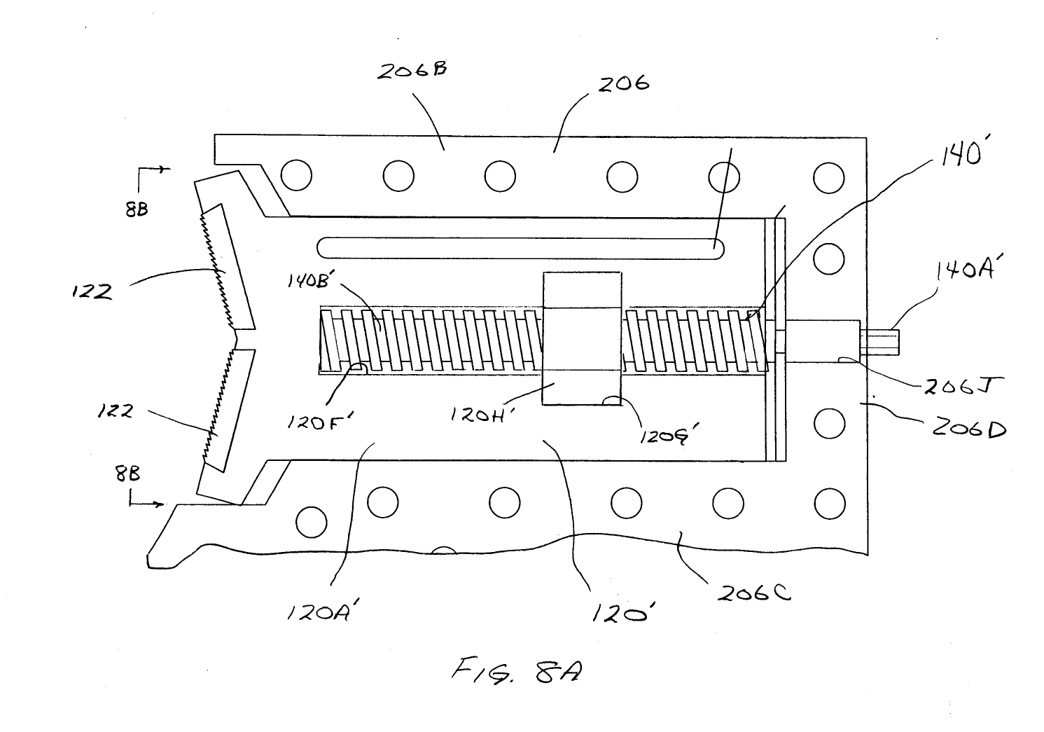

Each V-block 120 is equipped with a plurality of dies 122 made of hardened metal with teeth for gripping as shown in FIGS. 8A and 8B. The two V-blocks 120 with the plurality of dies 122 are adapted to hold fast a workpiece W (FIG. 5A), typically a pipe, that will be subject to torque loading.

Two V-blocks 120 each with two sets of dies 122 will create four points of contact for gripping and holding fast the workpiece W. In a preferred embodiment, each set of dies 122 are 1.750″ wide. Four sets of dies 122 will provide a total of seven inches of width for gripping and holding fast the workpiece W.

Referring to FIGS. 3 and 4, the central opening 30 of the vise unit 100 preferably includes a semi-circular lower portion 30A and straight upper portions 30B. As shown in FIG. 5A, the vise unit 100 defines a horizontal axis H, a vertical axis V and a centerpoint C at their intersection. Preferably, the vertical axis V is centrally located in the central opening 30 and the horizontal axis H is centrally located in the cavities with the received V-blocks 120.

In a preferred embodiment, each V-block 120 includes markings indicating the workpiece W or pipe diameter suited for the current position of the V-block 120. In use, it is preferred that the pipe W being secured by the vise unit 100 be centrally located or substantially centrally located within the central opening 30 such that the pipe centerpoint coincides with or substantially coincides with centerpoint C of the vise unit 100.

Referring to FIGS. 3, 4, 4A and 5, when the aperture 108H of the second interior member 108 is axially aligned with aperture 102H of the front and back first plate members 102, a gap is formed between the adjacent first and second plate members 102 and 104, respectively. The gap is best shown in FIG. 4A. The first plate member 102 includes two substantially planer edge surfaces 102J and 102K which meet and form an angle therebetween. The second plate member 104 includes two substantially planer edge surfaces 104J and 104K which meet and form an angle therebetween. The center of the apertures 102H and 108H defines an axis about which the second plate members 104, second interior member 108 and the received V-block 120, generally referred to as the pivoting assembly 160, are allowed to pivot or rotate. The extent of the pivotal or rotational movement is limited by the engagement of at least a portion of the edge 104K with the edge 102K to the engagement of at least a portion of the edge 104J to the edge 102J. The height of the gap is relatively small. In a preferred embodiment, the gap height is approximately 0.25″. Preferably the gap height is in the range of 0.125″ to 0.25″.

Referring to FIG. 5A, a hydraulic cylinder 142 is pin-connected to the fixed strut 112 via the end hole 112B and to the second interior member 108 via the projecting lug bore 108F.

A preferred method of using the vise unit 100 will now be described with reference to FIGS. 3, 4 and 5A. Initially, the V-blocks 120 are typically in their retracted position as shown in FIGS. 3 and 4. The operator will adjust the V-block 120 in the cavity defined by the non-pivoting first interior member 106, referred to as the non-pivoting assembly 162, to the position that corresponds with the diameter of the pipe W to be gripped. The V-block 120 is axially extended within the central opening 30 by rotating the stem assembly 140. Preferably, a drill can be used to rotate the stem assembly 140. The pipe W is positioned within the central opening 30 and oriented such that the length of pipe W is substantially horizontal and transverse to the horizontal axis H of the cavities and V-blocks 120. The pipe W is properly positioned vertically within the central opening 30 when the pipe contacts both the upper and lower dies of the extended V-block 120. The V-block 120 in the cavity defined by the pivoting second interior member 108, referred to as the pivoting assembly 160, is then axially positioned into contact with the pipe W such that the pipe W is contacting upper and lower dies 122 from both of the V-blocks 120. The hydraulic jack 142 is then actuated to slightly extend and pivot the pivoting assembly 160 in (clockwise in FIG. 5A) to lock onto the pipe W by the teeth of the dies creating a bite on the outer surface of the pipe W. At this point the vise unit 100 has securely gripped the pipe W to resist rotation of the pipe W. To release the pipe W, the applied force by the hydraulic jack 142 is released and the pivoting assembly 160 rotates out (counter-clockwise in FIG. 5A).

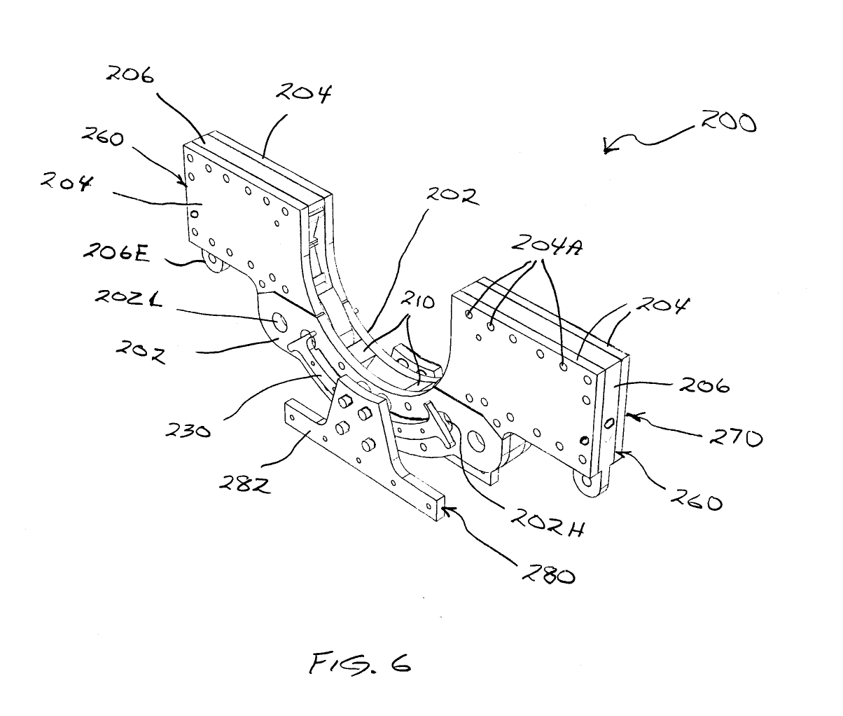

Turning now to the torque unit 200, FIG. 6 is a perspective view of the torque unit 200 shown in FIGS. 1 and 2, FIG. 7 is a front view (with the back view being identical), and FIG. 8 is a sectional view of the torque unit 200 in which the front members have been removed for purposes of explanation. In the preferred embodiment, the torque unit 200 and the vise unit 100 have many similarities.

For purposes of discussion, the torque unit 200 comprises a base frame 280 and a movable assembly 270. As will be explained in detail below, the movable assembly 270 is allowed to move relative to the base frame 280.

The front and back sides of the movable assembly 270 are each comprised of a first member 202 and a pair of second members 204, all preferably plate members. The first and second plate members 202 and 204 of the front side are separated from the first and second plate members 202 and 204 of the back side by a pair of interior members 206.

Referring to FIGS. 6-8, the second plate members 204 include a plurality of holes 204A forming a fastener hole pattern and the interior members 206 include a corresponding plurality of holes 206A in the same fastener hole pattern. The hole patterns are shown as having fifteen (15) holes 204A or 206A extending axially through the members 204 or 206, respectively. Although not shown, it is to be understood that a plurality of fasteners, one for each hole in the pattern are inserted through the corresponding hole in the front second plate member 204, the interior member 206 and the back second plate member 204 to secure the assembly together. Preferably, the fasteners are threaded bolts and nuts. It is to be understood that the number of holes and the hole patterns may vary depending on type and size of fasteners, load considerations and other design criteria.

Referring to FIGS. 6 and 8, a pair of spacer blocks 210 are secured between the front and back first plate members 202, preferably via fasteners (not shown) extending through aligned holes in the first plate members 202 and the spacer blocks 210. The fasteners are preferably threaded fasteners. In the preferred embodiment the fastener is flush or substantially flush with the outer surface of the first plate members 202.

Referring to FIG. 8, each interior member 206 includes an upper arm 206B, a lower arm 206C and a joining segment 206D. An opening is formed between the upper and lower arms 206B, 206C. Each interior member 206 includes a push lever 206E projecting from one or both of the joining segment 206D and the lower arm 206C. The push lever 206E includes a bore 206F therethrough. At least a portion of the push lever 206E extends beyond the adjacent peripheral surface of the second plate members 204. As best shown in FIG. 8, the interior member 206 also includes a connecting lug 206G projecting from an end of the lower arm 206C. The connecting lug 206G has first and second apertures 206H and 206L respectively, extending therethrough.

As shown in FIGS. 6-9, each first plate member 202 includes first and second apertures 202H and 202L respectively, at each end of the first plate member 202, arranged and designed to align axially with the corresponding apertures 206H and 206L of the connecting lug 206G of the interior member 206. Preferably, a connecting pin (not shown) is inserted into the aligned apertures 202H of the front and back first plate members 202 and aperture 206H of the interior member 206. The pin connection of the interior member 206 to the first plate members 202 is a pivot connection.

Still referring to FIGS. 6-8, a track member 230 is mounted on the outwardly facing surface of each first plate member 202. In the illustrated embodiment, the track member 230 and the first plate member 202 include a plurality of holes aligned to fasten the track member 230 to the first plate member 202. In the preferred embodiment the fastener is flush or substantially flush with the outer surface of the track member 230.

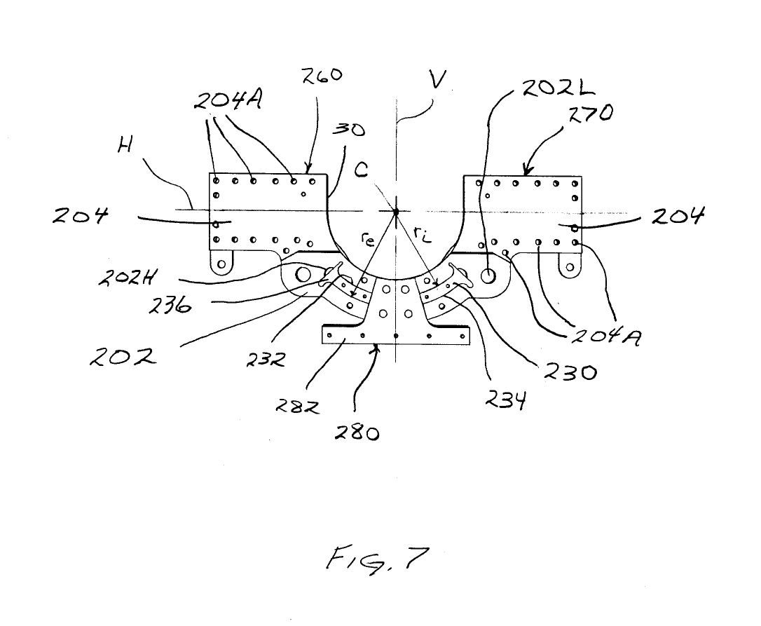

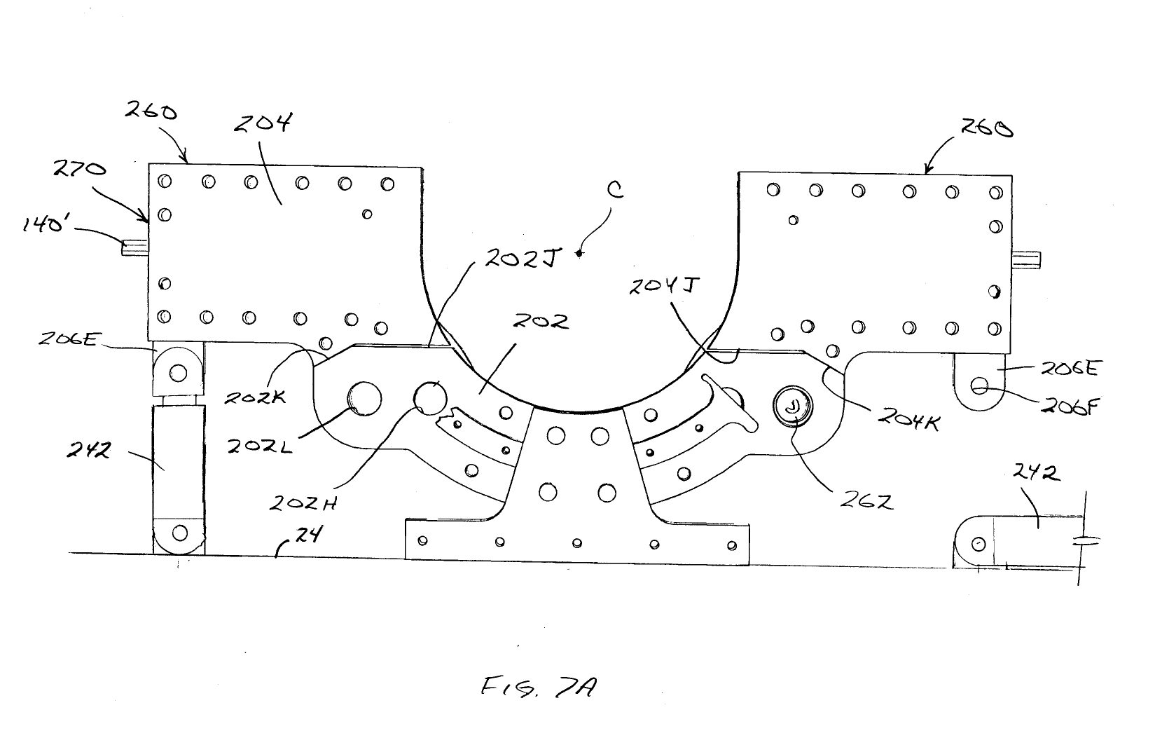

Referring to FIGS. 7 and 8, the central opening 30 of the torque unit 200 preferably includes a semi-circular lower portion 30A and straight upper portions 30B. As shown in FIG. 7, the torque unit 200 defines a horizontal axis H, a vertical axis V and a centerpoint C at their intersection. As with the vise unit 100, the vertical axis V is centrally located in the central opening 30 and the horizontal axis H is centrally located in the cavities with the received V-blocks 120.

It is to be understood that in a preferred embodiment a longitudinal axis L_{C} passing through the centerpoint C of the gripping unit and torque unit central openings 30 is parallel to a longitudinal axis L_{F} of the axial support beam of the vise and torque units as shown in FIG. 1.

Each track member 230 preferably includes an interior circular arc 232 having a radius rᵢ and an exterior circular arc 234 having a radius rₑ. Each of the circular arcs 232 and 234 have centerpoint C as the center of the circle. Preferably, each track member 230 includes at least one stop 236 at each end of the track member 230.

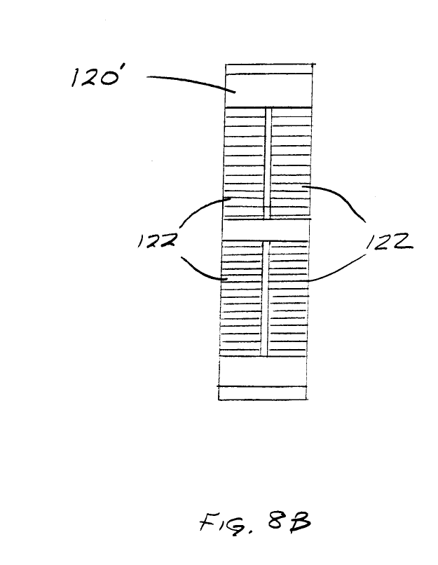

The movable assembly 270 is movably connected to the base frame 280 via the cooperating track members 230. The movable assembly 270 will partially rotate about centerpoint C inside the base frame 280. The base frame 280 includes a pair of side frame members 282. A plurality of guide rollers 284 are mounted on each side frame member 282. As shown in FIG. 9, the guide rollers 284 face the movable assembly 270. In FIG. 9, two guide rollers 284 are positioned above and two guide rollers 284 are positioned below each track member 230. The two upper rollers 284 are adapted to guide and contact the surface of the interior circular arc 232 and the two lower rollers 284 are adapted to guide and contact the surface of the exterior circular arc 234. In a preferred embodiment the movable assembly 270 will rotate through an arc of approximately 35 degrees.

The movable assembly 270 includes two pivoting assemblies 260, each having a V-block 120′, preferably identical to one another. The V-blocks 120′ in the torque unit 200 can be identical to the V-blocks 120 in the vise unit 100. Preferably, the pivoting assemblies 260 are identical to each other.

A second embodiment of the V-block 120′ is shown in FIG. 8A. As described above with respect to the vise unit 100, the V-block 120′ is received in a cavity formed by the opening between the upper and lower arms 206B, 206C of the interior member 206 and the front and back second plate members 204. The V-blocks 120′ translate axially within the cavity. A second means for translating the V-block 120′ is shown in FIG. 8A. An axial blind bore 120F′ is formed within the elongated body 120A′ and a window 120G′ is formed through the elongated body 120A′. The window 120G′ intersects the blind bore 120F′. An internally threaded member 120H′, for example a nut, is inserted into the window 120G′ and prevented from rotating within the window 120G′. A threaded shaft 140B′ of a stem assembly 140′ is inserted into the blind bore 120F′ and threaded onto the nut 120H′. The threaded shaft 140B′ has a length approximating the length of the blind bore 120F′ and is fully inserted into the blind bore 120F′. The stem assembly 140′ has an outer end 140A′ adapted to provide a means to rotate the stem assembly 140′ about its longitudinal axis. The outer end 140A′ extends through a bore 206J, preferably a stepped bore, in the joining segment 206D of the interior member 206. Preferably, upon installation the stem assembly 140′ is prevented from axial movement relative to the interior member 206.

As described above with respect to the vise unit 100, each V-block 120′ is equipped with a plurality of dies 122 made of hardened metal with teeth for gripping as shown in FIGS. 8A and 8B. The two V-blocks 120′ with the plurality of dies 122 are adapted to hold fast a workpiece W (FIG. 5A), typically a pipe, that will be subject to torsional loading.

Two V-blocks 120′ each with two sets of dies 122 will create four points of contact for gripping and holding fast the workpiece W. In a preferred embodiment, each set of dies 122 are 1.750″ wide. Four sets of dies 122 will provide a total of seven inches of width for gripping and holding fast the workpiece W.

In a preferred embodiment, each V-block 120′ includes markings indicating the workpiece W or pipe diameter suited for the current position of the V-block 120′. In use, it is preferred that the pipe W being turned and torqued by the torque unit 200 be centrally located or substantially centrally located within the central opening 30 such that the pipe centerpoint coincides with or substantially coincides with centerpoint C of the torque unit 200.

Referring to FIGS. 7, 7A and 8, when the aperture 206H (FIG. 8) of the interior member 206 is axially aligned with aperture 202H (FIG. 7A) of the front and back first plate members 202, a gap is formed between the adjacent first and second plate members 202 and 204, respectively. The gap is best shown in FIG. 7A. The first plate member 202 includes two substantially planer edge surfaces 202J and 202K which meet and form an angle therebetween. The second plate member 204 includes two substantially planer edge surfaces 204J and 204K which meet and form an angle therebetween. The center of the apertures 202H and 206H defines an axis about which the second plate members 204, interior member 206 and the received V-block 120′, generally referred to as the pivoting assembly 260, are allowed to pivot or rotate. The extent of the pivotal or rotational movement is limited by the engagement of at least a portion of the edge 204K with the edge 202K to the engagement of at least a portion of the edge 204J to the edge 202J. The height of the gap is relatively small. In a preferred embodiment, the gap height is approximately 0.25″ and may have a height in the range of 0.125″ to 0.25″. It is to be understood that each pivoting assembly 260 naturally, under its own weight and the effect of gravity, pivots to the outward position as shown in FIG. 7A. In this outward pivoting position, the gap is formed along the semi-circular portion 30A of the central opening 30 between the first and second plate members 202 and 204.

Referring to FIGS. 1, 2 and 7A, a pair of hydraulic cylinders 242 are preferably adapted to be pin-connected to the push lever 206E of the interior member 206 via the hole 206F. In a preferred embodiment of the torque unit 200, the hydraulic cylinders 242 are also pin-connected to a cross member support 24.

A preferred method of using the torque unit 200 will now be described with reference to FIGS. 6, 7, 7A, 7B and 8. The operator determines whether the pipe will be rotated clockwise or counter-clockwise. For purposes of explanation, we will assume the pipe needs to be rotated clockwise when viewing FIGS. 7A and 7B. A pin 262 is inserted into the axially aligned holes 202L of the first plate member 202 and 206L of the interior member 206 on the right side as shown in FIG. 7A. With the pin 262 inserted, the pivoting assembly 260 on the right side is prevented from pivotal movement and will be referred to as a “locked pivoting assembly.” No pin is installed in the corresponding holes of the pivoting assembly 260 on the left side of FIG. 7A. The hydraulic cylinder 242 on the left side of FIG. 7A is pin-connected to the push lever 206E and the hydraulic cylinder 242 on the right side is disconnected from the push lever 206E of the locked pivoting assembly 260.

The V-blocks 120′ are typically in their retracted position as shown in FIGS. 6, 7 and 7A. The operator will adjust the V-block 120′ in the locked pivoting assembly 260, to the position that corresponds with the diameter of the pipe W to be gripped and turned. The V-block 120′ is axially extended within the central opening 30 by rotating the stem assembly 140′ (FIG. 8A). Preferably, a drill can be used to rotate the stem assembly 140′. The pipe W is positioned within the central opening 30 and oriented such that the length of pipe W is substantially horizontal and transverse to the horizontal axis H of the cavities and V-blocks 120′. The pipe W is properly positioned vertically within the central opening 30 when the pipe contacts both the upper and lower dies 122 of the extended V-block 120′. The V-block 120′ in the cavity of the “unlocked” pivoting assembly 260 on the left side is then axially positioned into contact with the pipe W such that the pipe W is contacting upper and lower dies 122 from both of the V-blocks 120′.

The hydraulic jack 242 connected to the unlocked pivoting assembly 260 is then actuated to slightly extend and pivot inwardly (clockwise in FIG. 7A) the unlocked pivoting assembly 260 to lock onto the pipe W by the teeth of the dies creating a bite on the outer surface of the pipe W as the gap between the first and second plate members 202 and 204 along the semi-circular portion 30A of the central opening 30 is reduced or eliminated. At this point the torque unit 200 has securely gripped the pipe W.

With the dies 122 and the V-blocks 120′ securely gripping the pipe W, continued extension of the engaged hydraulic cylinder 242 results in the rotation of the movable assembly 270 about the centerpoint C. Pressure is applied by the V-blocks 120′ on the workpiece W to be turned and torqued when the push lever 206E is moved upward. The amount of pressure placed on the workpiece W will increase as more pressure is placed upwardly on the push lever 206E.

It is to be understood that in a typical situation, a first pipe is secured in the vise unit 100 and a second pipe is secured in the torque unit 200. The first and second pipes are threadedly coupled together at a location between the vise unit 100 and the torque unit 200. With reference to FIGS. 1 and 2, a pipe secured in the torque unit 200 will make-up and tighten a right hand thread threaded connection when the movable assembly 270 rotates clockwise. Upon the hydraulic cylinder 242 rotating the movable assembly 270 to its maximum point, the hydraulic cylinder 242 is retracted. As it begins to retract, the unlocked pivoting assembly 260 pivots outward and the grip of the dies 122 and V-blocks 120′ releases from the pipe W. As a result, the movable assembly 270 can be brought back to its initial position without rotating the pipe W. To continue rotating the pipe W in the clockwise direction, the hydraulic cylinder 242 is again extended such that the unlocked pivoting assembly 260 again grips the pipe W and then rotates the pipe W with continued extension of the hydraulic cylinder 242.

The torque unit 200 can also be used to break loose and unscrew a right-hand threaded connection. In this operation, the hold pin 262 is removed from the right side pivoting assembly 260 and installed in the left side pivoting assembly 260 of the torque unit 200 for a counter-clockwise turn. Additionally, the left hydraulic cylinder 242 is disconnected from the movable assembly 270 and the right hydraulic cylinder 242 is connected to the push lever 206E on the right side of the movable assembly 270. As discussed above with respect to the clockwise rotation, the counter-clockwise rotation is performed in the similar manner. With the pipe W centered and the dies 122 of the V-blocks 120′ contacting the pipe W, the hydraulic cylinder 242 is then actuated to slightly extend and pivot inwardly the unlocked pivoting assembly 260 to lock onto the pipe W by the teeth of the dies creating a bite on the outer surface of the pipe Was the gap between the first and second plate members 202 and 204 along the semi-circular portion 30A of the central opening 30 is reduced or eliminated. At this point the torque unit 200 has securely gripped the pipe W.

With the dies 122 and the V-blocks 120′ securely gripping the pipe W, continued extension of the engaged hydraulic cylinder 242 results in the counter-clockwise rotation of the movable assembly 270 about the centerpoint C. To release the grip of the dies 122 on the pipe W, the applied force by the hydraulic jack 242 is released and the unlocked pivoting assembly 260 pivots outwardly (clockwise in FIG. 7A) and the pipe grip is released as discussed above.

In both the clockwise and counter-clockwise pipe rotations, the pipe W turned and torqued will be firmly held fast when the appropriate push lever 206E is moved upward by the appropriate hydraulic cylinder 242. The dies 122 release their grip on the pipe W as the push lever 206E is moved downward.

Preferably, the V-blocks 120′ are adjustably positioned to accommodate a variety of different diameters of workpieces W to be turned and torqued. In the preferred embodiment, the same set of dies may be used in working with pipe diameters ranging from 2″ to 18″, for example.

The workpiece W to be turned and torqued is held within the torque unit 200 in a confined space during the torquing process. This provides a safe environment for personnel operating the unit. The vise unit 100 is made in the same style as the torque unit 200. Only one section that holds the V-blocks will pivot inward to hold the workpiece W.

Hydraulic cylinders will provide power to move the push lever on each V-block on both the torquing unit 200 and the vise unit 100. The vise unit 100 will operate with one hydraulic cylinder.

The torque unit 200 is designed to mount to a cart or table and tighten pipe or tools by rotating a free end of the joint. Gripping jaws are moved toward the center of the unit to contact the outer surface of the pipe or tool to be tightened. Each gripping jaw is moved toward the center of the tool the same distance. A vertical load is then applied to the movable assembly of the torque unit 200 to produce a torque on the pipe or tool.

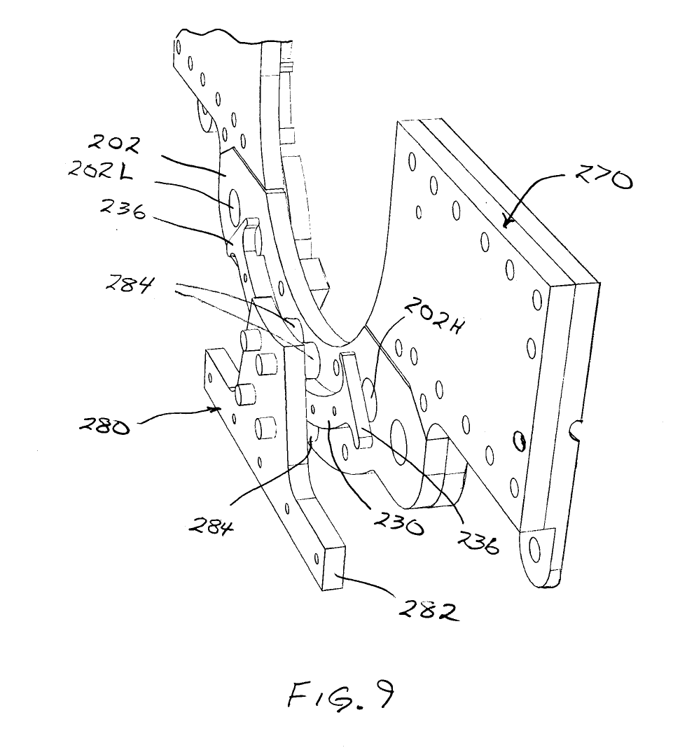

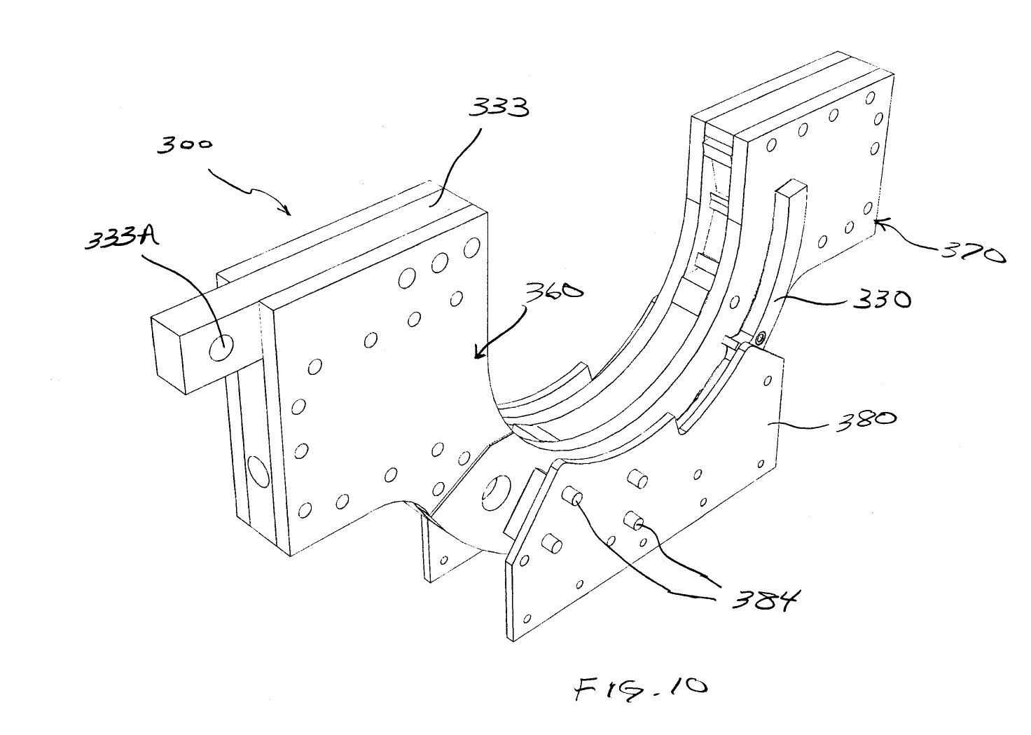

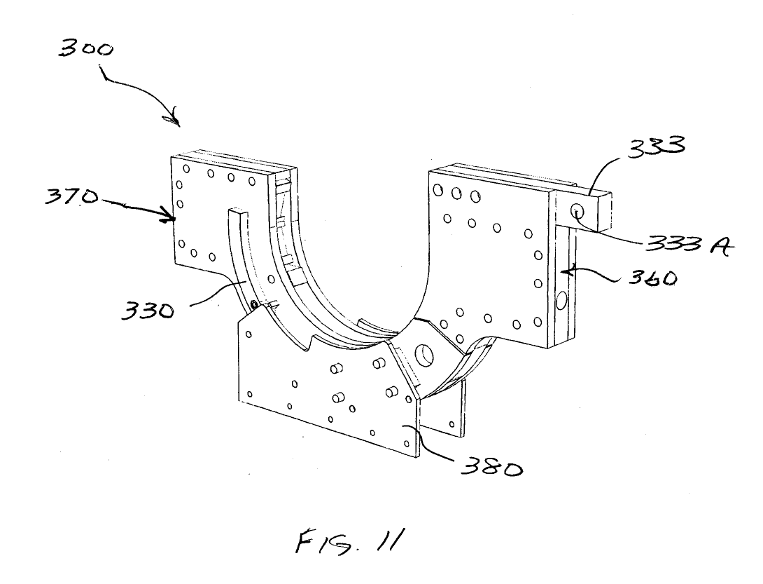

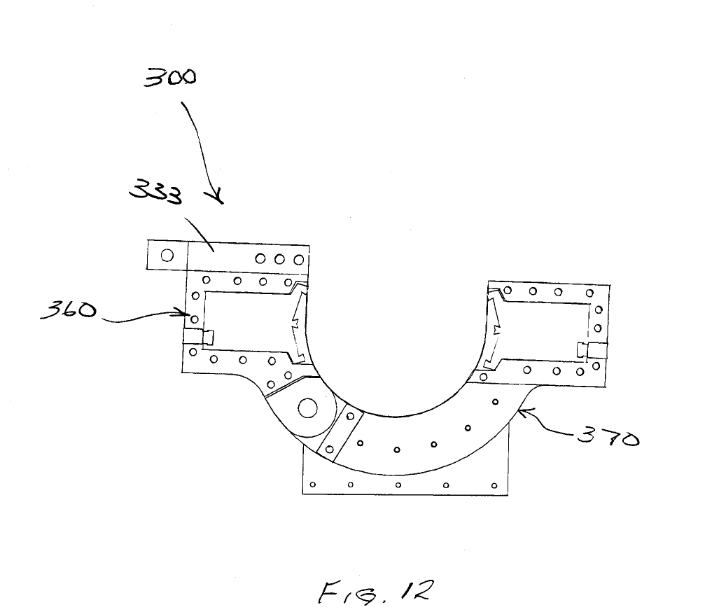

FIGS. 10-12 show an alternate embodiment of the torque unit, generally referred to as 300. The torque unit 300 is adapted to rotate only in one direction, for example the clockwise direction. The torque unit 300 includes a single pivoting assembly 360—similar generally to the pivoting assembly 160 of the vise unit 100 described above. The torque unit 300 includes a pair of V-blocks and a plurality of dies which can be similar or identical to V-blocks 120 or 120′ and dies 122. A base frame 380 includes a plurality of guide rollers 384 cooperating with track members 330 for guiding the movable assembly 370. In this embodiment a pull lever 333 is secured to the upper portion of the pivoting assembly 360, preferably with bolts and nuts. The pull lever 333 has an extending portion having a bore 333A therethrough.

The torque unit 300 is preferably pivoted and rotated from an actuator means or device positioned above the torque unit 300. For example, a powered unit or device may be connected to the pull lever 333 via the bore 333A from above and pull upwardly on the pull lever 333 to effectuate the rotational movement.

It is to be understood that in the preferred embodiments of the torque unit the movable assembly 270 and the workpiece W are vertically supported by the guide rollers 284—typically the lower guide rollers 284. When the side hydraulic cylinder is pressured up to effect pivot and rotation, unequal lateral and vertical forces are exerted on the upper and lower guide rollers 284. This is additionally contributed to by manufacturing and assembly tolerances between the upper and lower guide rollers with respect to the track member 230. As a result, if the pipe W is not centered in the torque unit—for example a ¼″ higher than centered—there is a possibility that some slippage of the dies relative to the pipe W occurs during the pressuring up of the hydraulic cylinder. However, proper centering of the pipe W eliminates the chances of slippage of the dies during the process. In instances where centering of the pipe W is easily controlled or achieved, the torque device 200 works extremely well without slipping. In instances where the pipe centering is more difficult or timely to accomplish, the following embodiment allows for pipe torqueing without slippage—even with the pipe slightly off-center.

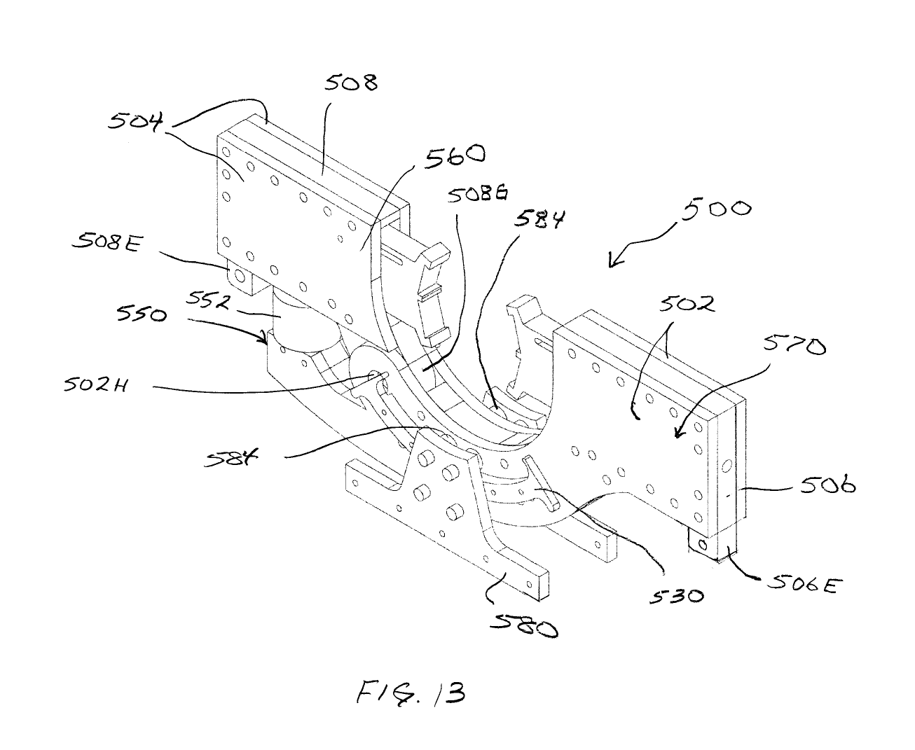

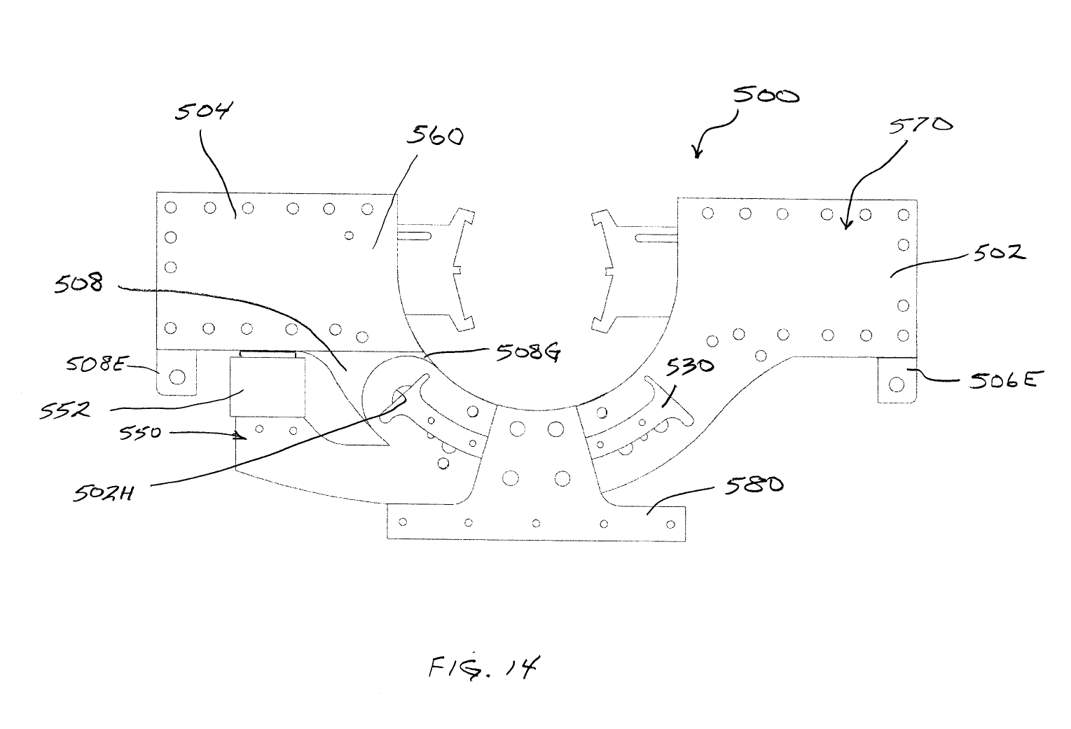

The following embodiment alleviates the likelihood of slippage resulting from the failure to properly center the pipe W. FIGS. 13 and 14 disclose another preferred embodiment of the torque unit, generally referred to as 500. Several features of the torque unit 500 are similar or identical to the features of vise unit 100 and torque units 200 and 300. As a result the following discussion will focus primarily on the differences of torque unit 500.

The torque unit 500 is adapted to rotate in both directions—clockwise and counter-clockwise. The torque unit 500 includes a single pivoting assembly 560—similar generally to the pivoting assembly 160 of the vise unit 100 described above.

Preferably the front and back sides of the torque unit 500 are substantially mirror images of one another. The front and back sides are each comprised of first and second members 502 and 504, respectively, preferably plate members. The first and second plate members 502 and 504 of the front side are separated from the first and second plate members 502 and 504 of the back side by first and second interior members 506 and 508, respectively. Each of the first and second interior members 506 and 508 includes a push lever 506E and 508E, respectively, extending downwardly.

The torque unit 500 includes a pair of V-blocks and a plurality of dies which can be similar or identical to V-blocks 120 or 120′ and dies 122. Each V-block 120 or 120′ comprises an elongate body 120A or 120A′ adapted to axially translate within the cavity. Various means may be used to axially translate the V-block, including but not limited to threaded stem assemblies 140 or 140′.

A base frame 580 includes a plurality of guide rollers 584 cooperating with track members 530 for guiding the movable assembly 570.

The first plate members 502 include an aperture 502H arranged and designed to align axially with the aperture (not shown) of the connecting lug 508G. A connecting pin (not shown) is inserted into the aligned apertures 502H of the front and back first plate members 502 and the aperture of the second interior member 508. It is to be understood that the pin connection of the second interior member 508 to the first plate members 502 is a pivot connection.

The torque unit 500 includes a support arm 550 formed integrally with, or connected to the front and back first plate members 502. The support arm 550 extends below the pivoting assembly 560. A hydraulic cylinder 552 is located between the pivoting assembly 560 and the support arm 550. As the hydraulic cylinder 552 is pressurized to extend the piston, the push of the piston acts on the pivoting assembly 560 closing the V-block against the workpiece W. This action locks the pipe W between the two V-blocks in a separate step from rotating the movable assembly 570. The dies thus get a firm bite on the pipe W prior to any rotation of the movable assembly occurring. The movable assembly 570 is then rotated by one of the hydraulic cylinders 242 (see FIGS. 7A and 7B). With reference to FIG. 14, the left hydraulic cylinder 242 is connected to the push lever 508E for clockwise rotation of the pipe with the right hydraulic cylinder 242 not connected to push lever 506E, whereas the right hydraulic cylinder 242 is connected to the push lever 506E for counter-clockwise rotation of the pipe with the left hydraulic cylinder 242 not connected to push lever 508E.

In this embodiment of the torque unit 500, the piston of the hydraulic cylinder 552 is retracted in order to release the grip on the pipe. Upon release, the hydraulic cylinder 242 connected to the movable assembly 570 can be retracted without rotational movement of the pipe. If continued rotation is desired, the hydraulic cylinder 552 is actuated to grip the pipe and then hydraulic cylinder 242 is actuated to effect rotation.

In each of the described preferred embodiments of the torque and vise units, a pair of V-blocks with dies are utilized. In each of these embodiments it is desirable that the centerpoint C be equidistant from each of the V-blocks. Thus, when centering the pipe W each of the V-blocks will be the same distance from the centerpoint C. Although not shown, in a preferred embodiment, linkage is provided such that a hand wheel or motor moves the V-blocks simultaneously so that the centerpoint C is always equidistant between the two V-blocks.

Preferably, the V-block dies of the torque units described herein are brought into contact with the pipe when centering the pipe and then slightly “backed off” to form a gap of approximately ⅛″ to ¼″. This gap is closed or “taken up” when the pivot assembly is actuated to grip the pipe. This allows the movable assembly to rotate freely relative to the pipe when the pivot assembly is released.

As described herein, the distance between the torque and vise units can be adjacent—approximately 6″ apart—or spaced 8′ or more from one another depending on the frame length.

It is to be understood that the embodiments shown and described are preferred embodiments and the invention is not limited to these disclosed embodiments. It is to be further understood that the invention is not limited to the exact details of construction, operation, exact materials or embodiments shown and described, as obvious modifications and equivalents will be apparent to one skilled in the art. Accordingly, the invention is therefore to be limited only by the scope of the appended claims. While the specific embodiments have been illustrated and described, numerous modifications come to mind without significantly departing from the spirit of the invention, and the scope of protection is only limited by the scope of the accompanying claims.

We claim:

1. A gripping unit for engaging a workpiece, the unit comprising:
a first assembly;
a second assembly pivotally connected to the first assembly, the second assembly having a limited range of pivotal movement relative to the first assembly,
wherein the first and second assemblies define a central opening of the gripping unit;
each of the first and second assemblies including a V-block oppositely disposed from one another and capable of axial translation within the central opening to engage a workpiece;
an actuator arranged and designed to pivot the second assembly relative to the first assembly in the direction of the central opening.

2. The gripping unit of claim 1, wherein the range of pivotal movement is limited by the engagement of opposing surfaces of the first and second assemblies.

3. The gripping unit of claim 1, further comprising a plurality of dies attached to each V-block for engaging the workpiece.

4. The gripping unit of claim 1, wherein the actuator is a hydraulic cylinder.

5. The gripping unit of claim 1, wherein the second assembly includes a push lever and the actuator is attached to the push lever.

6. The gripping unit of claim 1, wherein each of the first and second assemblies includes means for adjusting the axial translation of the V-block.

7. The gripping unit of claim 1, wherein each of the first and second assemblies includes a threaded stem assembly for adjusting the axial translation of the V-block.

8. The gripping unit of claim 1, wherein each of the first and second assemblies includes a cavity, oppositely disposed from one another, for receiving at least partially one V-block.

9. The gripping unit of claim 1, further comprising a base frame, wherein the first assembly is movably connected to the base frame.

10. The gripping unit of claim 9, wherein the base frame includes a plurality of guide rollers and the first assembly includes at least one track member, and the plurality of guide rollers and the at least one track member cooperate to allow movement of the first and second assemblies relative to the base frame.

11. The gripping unit of claim 10, wherein the central opening has a centerpoint defined by the intersection of a vertical central axis of the central opening and a central axis of the opposing V-blocks, and
the allowed movement of the first and second assemblies relative to the base frame is a circular arc about the central opening centerpoint.

12. The gripping unit of claim 10, wherein the actuator is connected to the second assembly and arranged and designed to move the first and second assemblies relative to the base frame.

13. The gripping unit of claim 10, further comprising a second actuator arranged and designed to move the first and second assemblies relative to the base frame, the second actuator connected to one of the first and second assemblies.

14. An apparatus for making and breaking a threaded connection between first and second tubular members, comprising:
a gripping unit comprising:
a first assembly;
a second assembly pivotally connected to the first assembly, the second assembly having a limited range of pivotal movement relative to the first assembly,
wherein the first and second assemblies define a central opening of the gripping unit;
each of the first and second assemblies including a V-block oppositely disposed from one another and capable of axial translation within the central opening to engage the first tubular member; and
a first actuator arranged and designed to pivot the second assembly relative to the first assembly in the direction of the central opening; and
a torque unit comprising:
a third assembly;
a fourth assembly pivotally connected to the third assembly, the fourth assembly having a limited range of pivotal movement relative to the third assembly,
wherein the third and fourth assemblies define a central opening of the torque unit;
each of the third and fourth assemblies including a V-block oppositely disposed from one another and capable of axial translation within the torque unit central opening to engage the second tubular member;
a second actuator arranged and designed to pivot the fourth assembly relative to the third assembly in the direction of the torque unit central opening; and
a base frame, wherein the third assembly is movably connected to the base frame.

15. The apparatus of claim 14, wherein the base frame of the torque unit includes a plurality of guide rollers and the third assembly includes at least one track member, and the plurality of guide rollers and the at least one track member cooperate to allow movement of the third and fourth assemblies relative to the base frame.

16. The apparatus of claim 14, wherein the central opening of the torque unit has a centerpoint defined by the intersection of a vertical central axis of the central opening and a central axis of the opposing V-blocks of the torque unit, and
the allowed movement of the third and fourth assemblies relative to the base frame is a circular arc about the central opening centerpoint of the torque unit.

17. The apparatus of claim 14, wherein the second actuator is connected to the fourth assembly and arranged and designed to move the third and fourth assemblies relative to the base frame.

18. The apparatus of claim 14, further comprising a third actuator arranged and designed to move the third and fourth assemblies relative to the base frame, the third actuator connected to one of the third and fourth assemblies.

19. The apparatus of claim 14, further comprising a stationary frame, the gripping unit and the torque unit being secured to the stationary frame.

20. The apparatus of claim 19, wherein the stationary frame has a length and the gripping unit is capable of being moved along at least a portion of the length of the stationary frame.

21. The apparatus of claim 20, wherein
the central opening of the gripping unit has a gripping unit opening centerpoint defined by the intersection of a vertical central axis of the gripping unit central opening and a central axis of the opposing V-blocks of the gripping unit, and
the central opening of the torque unit has a torque unit opening centerpoint defined by the intersection of a vertical central axis of the central opening and a central axis of the opposing V-blocks of the torque unit, and the allowed movement of the third and fourth assemblies relative to the base frame is a circular arc about the torque unit opening centerpoint,
wherein a longitudinal axis passing through the centerpoint of the gripping unit and torque unit central openings is parallel to a longitudinal axis of the stationary frame.

22. A method of securing a first tubular member against axial rotation, comprising:
providing a gripping unit having a second assembly pivotally connected to a first assembly and defining a central opening of the gripping unit;
providing each of the first and second assemblies with a V-block oppositely disposed from one another and axially translatable within the central opening;
positioning the V-blocks of the first and second assemblies within the central opening into slight contact with the first tubular member;
activating a first fluid powered cylinder to pivot the second assembly relative to the first assembly in the direction of the central opening to firmly grip the first tubular member.

23. The method of claim 22, wherein the V-blocks are positioned simultaneously.

24. The method of claim 22, wherein the step of positioning the V-blocks includes centering the first tubular member within the central opening.

25. The method of claim 22, further comprising:
providing a base frame to which the first assembly is movably connected;
wherein the central opening has a centerpoint defined by the intersection of a vertical central axis of the central opening and a central axis of the opposing V-blocks, and
allowing movement of the first and second assemblies relative to the base frame in a circular arc about the central opening centerpoint.

26. The method of claim 25, further comprising activating the first fluid powered cylinder to move the first and second assemblies relative to the base frame.

27. The method of claim 25, further comprising activating a second fluid powered cylinder to move the first and second assemblies relative to the base frame.
